(19) United States
(12) Patent Application Publication
(10) Pub. No.: US 2025/0321591 A1
(43) Pub. Date: Oct. 16, 2025

(54) SYSTEMS AND METHODS FOR DRONE NAVIGATION

(71) Applicant: General Dynamics Mission Systems, Inc., Fairfax, VA (US)

(72) Inventors: Benjamin A. Strasser, Minneapolis, MN (US); Daniel Andrés Duque, Fairfx, VA (US)

(73) Assignee: General Dynamics Mission Systems, Inc., Fairfax, VA (US)

(21) Appl. No.: 18/732,202

(22) Filed: Jun. 3, 2024

Related U.S. Application Data
(60) Provisional application No. 63/632,792, filed on Apr. 11, 2024.

(51) Int. Cl. G05D 1/644; G05D 1/246; G05D 109/20

(52) U.S. Cl. CPC G05D 1/644; G05D 1/2462; G05D 2109/20

(57) ABSTRACT

Systems and methods are described herein that facilitate the navigation of drones, including autonomous and semi-autonomous drones. These systems and methods particularly applicable to the facilitation of drones in underserved environments. For example, the systems and methods can facilitate the navigation of drones using a spatial obstruction database. In these embodiments the spatial obstruction database can abstract obstructions in a variety of ways, including as defined subregions. As other examples, the systems and methods can facilitate the navigation of drones using techniques for determining navigation paths. As other examples, the systems and methods can facilitate the navigation of drones using techniques for evaluating navigation paths to determine if line-of-sight path segments are open for navigation. As will be described below, these systems and methods are particularly applicable to the navigation of autonomous and semi-autonomous drones that may have limited processing and memory capabilities.

### CROSS-REFERENCE TO RELATED APPLICATIONS

This application claims the benefit of U.S. Provisional Application No. 63/632,792, filed on Apr. 11, 2024. The disclosure of the above application is incorporated herein by reference.

### TECHNICAL FIELD

The present invention generally relates to navigation systems and methods, and more particularly relates to systems and methods for the navigation of drones.

### BACKGROUND

Drones are used for a variety of applications in modern society. In general, drones are unmanned vehicles, and are implemented with a variety of propulsion systems and power systems. As main examples, drones can be implemented as both fixed wing and rotary unmanned aerial vehicles (UAVs).

One issue with the use of drones today is navigation. Specifically, providing for the navigation of drones in complex environments can be exceedingly difficult and unreliable. This is especially true for drones where autonomous or semi-autonomous navigation is desired.

This is especially true in areas with limited infrastructure. For example, it can be very difficult to navigate drones in areas where data communication is limited. For example, in underserved environments (e.g., restricted environments or remote environments) during times of natural and man-made disasters, conflicts, or other such situations can be critical in providing effective responses to such situations. Specifically, during a natural disaster local internet and other communication links may be unreliable, degraded or fully inoperable.

Hence, there is an ongoing need for improved drone navigation systems and methods, especially systems and methods that can effectively provide drones with the ability navigate with high degrees of autonomy in a variety of restricted environments. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

The various embodiments described herein provide systems and methods that facilitate the navigation of drones, including autonomous and semi-autonomous drones. As will be described in greater detail below, these systems and methods are particularly applicable to the facilitation of drone navigation in restricted environments.

In one embodiment, a system comprises a spatial obstruction database for a geographic region, where the spatial obstruction database represents physical features and airspace restrictions in the geographic region as abstracted spatial obstructions with the spatial obstruction database; and at least one processor configured to: identify a starting position and a destination position in the geographic region; repeatedly identify a potential path segment in the geographic region, and for each identified potential path segment: determine if the potential path segment is open to navigation; responsive to determining that the potential path segment is open to navigation, add the potential path segment to a navigation path network and determine a cost factor of the potential path segment; repeatedly link together potential path segments in the navigation path network to generate a plurality of navigation paths from the starting position to the destination position; and determine a final navigation path from the starting position to the destination position based at least in part on the cost factor of the potential path segments in the plurality of navigation paths.

In another embodiment, a method is provided, comprising: providing a spatial obstruction database for a geographic region, where the spatial obstruction database represents physical features and airspace restrictions in the geographic region as abstracted spatial obstructions with the spatial obstruction database; identifying a starting position and a destination position in the geographic region; repeatedly identifying a potential path segment in the geographic region, and for each identified potential path segment: determining if the potential path segment is open to navigation; responsive to determining that the potential path segment is open to navigation, adding the potential path segment to a navigation path network and determine a cost factor of the potential path segment; repeatedly linking together potential path segments in the navigation path network to generate a plurality of navigation paths from the starting position to the destination position; and determining a final navigation path from the starting position to the destination position based at least in part on the cost factor of the potential path segments in the plurality of navigation paths.

Furthermore, other desirable features and characteristics of the system and methods will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a schematic diagram illustrating an exemplary drone navigation in accordance with various embodiments;

FIG. 2 is a schematic diagram illustrating an drone navigation system in accordance with various embodiments;

FIG. 3 is a flow diagram illustrating a method of generating a navigation path in accordance with various embodiments;

FIG. 4 is a flow diagram illustrating a method of determining a final navigation path in accordance with various embodiments;

FIG. 5 is a flow diagram illustrating a method of evaluating path segments in accordance with various embodiments;

FIGS. 6A, 6B, 6C and 6D are schematic diagrams of generation of a navigation path in accordance with various embodiments; and

FIGS. 7A and 7B are schematic diagrams of volumes in a spatial obstruction database in accordance with various embodiments.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

The various embodiments described herein provide systems and methods that facilitate the navigation of drones, including autonomous and semi-autonomous drones. As will be described in greater detail below, these systems and methods are particularly applicable to the facilitation of drones in underserved environments.

For example, the systems and methods can facilitate the navigation of drones using a spatial obstruction database. In these embodiments the spatial obstruction database can abstract obstructions in a variety of ways, including as defined subregions. As other examples, the systems and methods can facilitate the navigation of drones using techniques for determining navigation paths. As other examples, the systems and methods can facilitate the navigation of drones using techniques for evaluating navigation paths to determine if line-of-sight path segments are open for navigation. As will be described below, these systems and methods are particularly applicable to the navigation of autonomous and semi-autonomous drones that may have limited processing and memory capabilities.

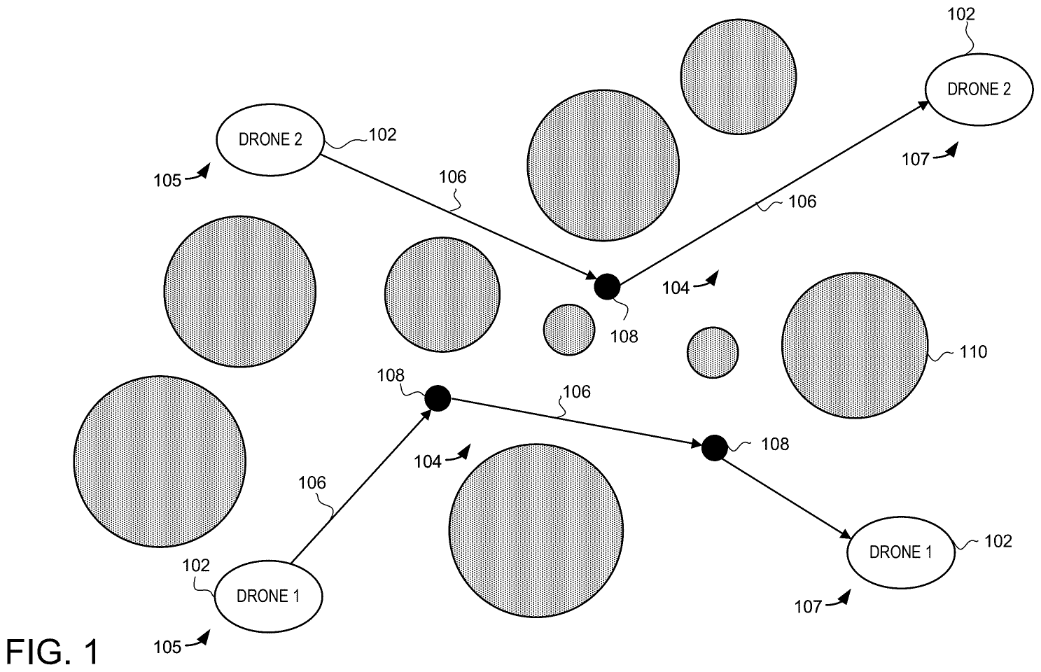

Turning now to FIG. 1, an example of a drone navigation through a restricted environment is illustrated schematically. The drone navigation is an example of the type of navigation that can be facilitated using the systems and methods described herein. In this example, two drones 102 (DRONE 1, DRONE 2) are navigated from starting positions 105 to destination positions 107. In each case the drones navigate over a navigation path 104 that includes a plurality of path segments 106 and includes points 108 along the navigation path 108. Inter-dispersed between the various drones 102 are a plurality of obstructions 110. These obstructions 110 represent any type of structure or feature that can interfere with communication. Thus, the obstructions 110 can thus include structures (e.g., buildings, bridges, dams), electromagnetic and other types of interference (e.g., jamming signals), geographic features (e.g., hills, cliffs), restricted areas or any other type of structure of feature that could interfere with travel of drones 102.

Notably, the navigation paths 104 are implemented to avoid the obstructions 110. As will be described in greater detail below, in some embodiments navigation paths 104 are implemented with path segments 106 using techniques for evaluating line-of-sight (LOS) path segments for open travel (e.g., avoiding the obstructions 110).

It should be noted that FIG. 1 is a very simplified example, and that in real-world applications such drone systems may include more drones 102 over a much larger area (that includes more obstructions 110). Thus, such drone navigation paths 104 can be implemented as a large and complex navigation path over a much larger area, where the larger area includes many more obstructions 110 to be avoided.

In general, the drones 102 can be implemented with any suitable type of unmanned vehicle (UV). Specifically, the drones 102 can be implemented with a variety of propulsion and power systems. As one specific example, the drones 102 can be implemented with both fixed wing and rotary unmanned aerial vehicles (UAVs).

One or more of the drones 102 can be implemented with any suitable combination of processor and data storage suitable to implement the various systems and methods described herein. For example, the drones can include any custom made or commercially available processor, including a central processing unit (CPUs), an auxiliary processor among several processors associated with the drone, microprocessor, macroprocessor, or any combination thereof, or generally any computing device for executing instructions. The drones can likewise include any data storage, including volatile and nonvolatile storage in read-only memory (ROM), random-access memory (RAM), and keep-alive memory (KAM). The data storage can further include devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions.

The drones 102 may also be implemented to include suitable communication devices. In these embodiments, the drones 102 would typically include the combination of antennas, transmitters, receivers, hardware and/or software needed to provide communication with other entities, including other drones. As specific examples, the drones 102 can be implemented to include communication devices for line-of-sight (LOS) communication using radio (e.g., 5G, directed RF) or optical signals that can provide relatively high-bandwidth communication.

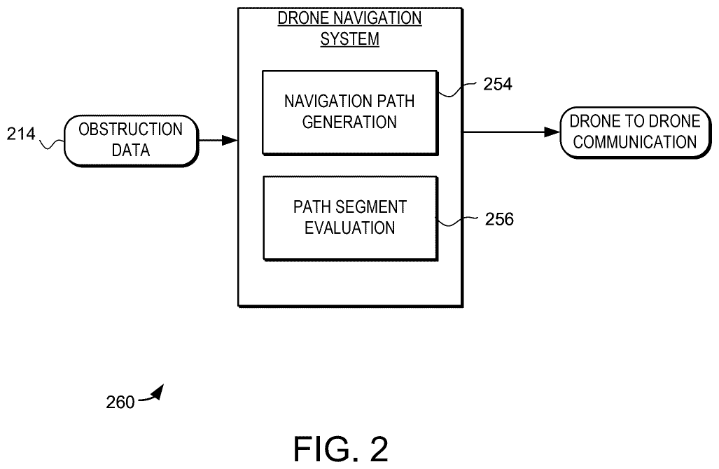

Turning now to FIG. 2A, a schematic view of a drone navigation system 260 is illustrated. In general, the drone navigation system 260 is an example of the type of system that can be implemented to facilitate drone navigation. Furthermore, the drone navigation system 260 can be implemented to be executed on one or more of the drones (e.g., drones 102 of FIG. 1). So implemented, the drone navigation system 200 can provide for autonomous or semi-autonomous navigation of drones.

In other embodiments the various components and functionality of the drone navigation system 260 can be distributed throughout the network. Thus, some components may be implemented on one or more drones, while other components are implemented on other devices or systems that are connected to the drones.

In the example of the FIG. 2, the drone navigation system 260 includes navigation path generation module 254 and a path segment evaluation module 256. Also, in this example, the drone navigation system 260 uses obstruction data 214.

The obstruction data 214 can include any needed data regarding structures and features that can interfere with the movement of drones. As such, this obstruction data 214 can include data on structures and features (e.g., buildings, terrain, electromagnetic or other interference) and data on restricted areas (e.g., areas with restricted airspace or other no-go areas). As will be described in greater detail below, this obstruction data 214 can be provided in the form of spatial obstruction database that facilitates specific query techniques to quickly access the data in a way that reduces the required computational resources. For example, the obstruction data 214 can be provided in the form of a spatial obstruction database that is optimized for three dimensional queries. As another example, the obstruction data 214 can be provided in the form of a spatial obstruction database that represents physical features in a geographic region as abstracted spatial obstructions. In such an embodiment the abstracted spatial obstructions can represent geographic regions as a plurality of subregions, where for each of the plurality of subregions that includes an obstruction, the subregion is identified as obstructed to an obstructed high point.

In general, the navigation path generation module 254 is implemented to generate navigation paths for drones to follow. As such, the navigation path generation module 254 can be used to guide drones to assigned positions for a variety of purposes.

The path segment evaluation module 256 is implemented to determine if candidate path segments in a possible navigation path are unobstructed for navigation. As will be described in greater detail below, the path segment evaluation module 256 can be implemented to utilize obstruction data 214 in a spatial obstruction database in evaluating candidate path segments for obstruction.

And as was described above, this obstruction data 214 can be provided in the form of a spatial obstruction database. Because this spatial obstruction database can be stored and used on one or more of the drones, and because such drones may have limited power and computational resources, it can be important to reduce the computational resources required to store and use the spatial obstruction database.

As was described above, this obstruction data stored in the spatial obstruction database can include data on obstructions resulting from structures and features (e.g., buildings, terrain, electromagnetic interference). In one embodiment, the spatial obstruction database is optimized for three dimensional queries in a way that also conserves the required computational resources. The spatial obstruction database can be configured to allow queries based on obstruction type or category. For example, the spatial obstruction database can be configured to allow queries based on ability to communicate between two points in space (e.g., avoiding buildings, terrain, and electromatic interference). For example, the spatial obstruction database can be configured to allow queries based on ability to maneuver between two points in space (e.g., avoiding buildings, terrain, and restricted airspaces).

The spatial obstruction database can be generated in part by taking high resolution spatial data and abstracting the data. For example, a LIDAR scan of a geographic area can provide a high-resolution 3D representation of all physical features in geographic area. Such a high-resolution 3D representation can then be abstracted to reduce the size and complexity of the data when stored in the spatial obstruction database. Abstracting the data in the spatial obstruction database can thus conserve computational resources, including the memory needed on the drones to store and access the database.

Specifically, the spatial obstruction database can be implemented such that obstructions resulting from physical and other features are abstracted to larger three-dimensional (3D) subregions that contain the obstructions, where the entire 3D subregion is then identified as obstructed in the database. As an example, obstructions can be abstracted to 3D subregions having a defined footprint area and a specified altitude. As more specific examples, these obstructions can be abstracted to 3D subregions in the form of larger parallelepipeds such as cuboids.

For example, the buildings and/or trees can be abstracted to a 3D subregion having an altitude that is at least equal to the tallest portion any building or tree within the footprint area of the 3D subregion. Thus, buildings, trees, and other obstruction creating features are abstracted into 3D subregions, where the 3D subregion has an altitude equal to the tallest point of any building, tree or feature in the footprint area. In such embodiments the 3D subregion can be abstracted from the lowest elevation to the altitude of the highest obstructed point in the 3D subregion. In other embodiments the 3D subregion can be abstracted from the altitude of lowest obstructed point in the subregion to the altitude of the highest obstructed point in the 3D subregion.

As one specific example of an abstracted spatial obstruction database, each 3D subregion could have a rectangular footprint, with the height of each subregion at least equal to the height of the highest obstructed point in that footprint. In this embodiment each subregion is cuboid, again with the altitude at least equal to the height of the highest obstructed point in rectangular footprint. And in this embodiment the rectangular footprints can have different sizes to efficiently represent the abstracted obstructions in the spatial obstruction database.

Such an abstracted spatial obstruction database can provide obstruction data while significantly reducing the computational resources needed to store and/or access the database. This reduction of resources can be especially significant where the spatial obstruction database is stored on one or more of the drones, as such drones may have limited computational resources and power conservation is of great importance.

As described above, in one embodiment the spatial obstruction database is optimized for three dimensional queries. As a specific example, the spatial obstruction database can be implemented as an R-tree data structure, including three-dimensional Priority R-tree data structures. R-tree data structures allow for the representation of obstructions as varying sized cubes and parallelepipeds. Again, allowing for different sized cubes and parallelepipeds can provide for efficient representation of abstracted obstructions. Furthermore, R-tree data structures facilitate the representation of homogeneous obstructions as a single large block, further providing for efficient representation and improving process time. Finally, R-tree data structures can be used to allow for the updates to the spatial obstruction database as new data is provided (e.g., from real time onboard LIDAR sensors on drones).

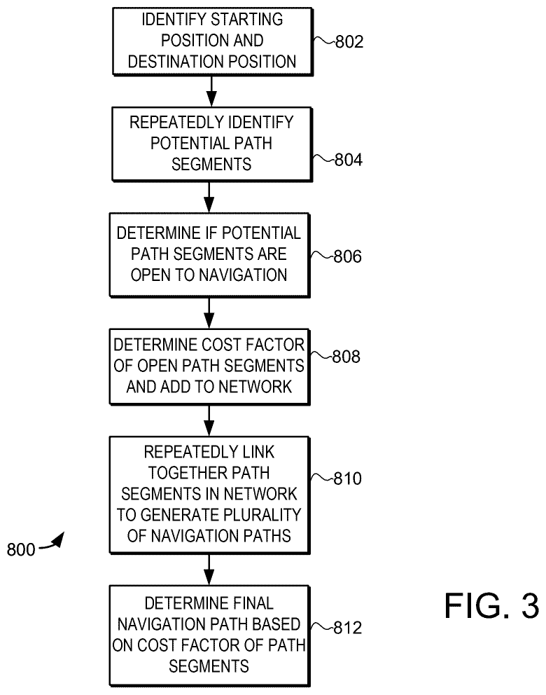

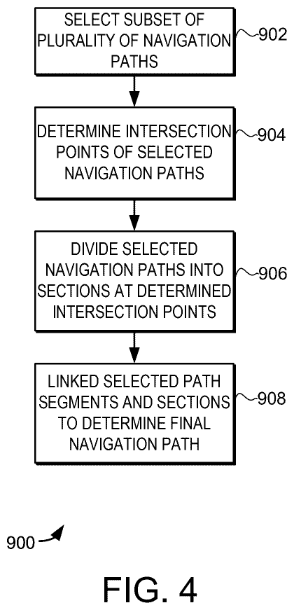

Turning now to FIG. 3, a method 800 for generating a navigation path is illustrated. As such, the method 800 is an example of a method that can be performed by the navigation path generation module 254 of FIG. 2. Specifically, the method 800 can be used to generate navigation paths to guide drones to assigned positions in a drone network. As will be described below, in one embodiment the method 800 utilizes a method 900 (of FIG. 4) for identifying a final navigation path is illustrated.

At step 802 the method 800 identifies a starting position and a destination position for the navigation path. In a typical embodiment step 802 the starting position is identified as a current or known future position of the drone with a geographic area. In the case of the known future position the starting position could correspond to a future assigned drone position in a drone network, or any other future position of the drone. However, these are just two examples of starting positions, and other starting positions within a geographic can be used.

Likewise, the destination position corresponds to a selected destination for the navigation path. The destination position could thus correspond to any desired destination for the drone. For example, the destination position can correspond to an assigned drone position in the drone network. In this case the navigation path provides a path from the current location to the assigned drone location. As examples, these starting and destination drone positions can be expressed as three-dimensional positions in the form of latitude, longitude, altitude (LLA) or Northing value, Easting value, down (NED).

In all these cases the starting position and destination positions are identified and used in generating the navigation path. At step 804 potential path segments are repeatedly identified. In general, this step is used to generate a large number of path segments that can be later connected together to generate multiple possible navigation paths between the starting position and destination position.

In one embodiment potential path segments are identified using a random tree selection of candidate points in the geographic area, where the candidate points define potential path segments. In some embodiment this random tree exploration is directed to perform the selection of candidate points in areas around and between the starting position and the destination position. Again, these candidate points can be expressed as three-dimensional positions in the form of latitude, longitude, altitude (LLA) or Northing value, Easting value, down (NED). Notably, this can include a selection of candidate points that may result in the navigation path heading in the wrong direction. However, these candidate points are included as it may be desirable for the navigation path to travel around obstructions by moving away from the destination at times. Directing the exploration toward these areas can thus improve the efficiency of the exploration and the identification of candidate points that correspond to potential path segments.

In some embodiments the candidate points and potential path segments can be selected utilizing a random tree selection of points in the geographic region proximate the starting position, points proximate the destination position, and points between the starting position and ending position.

In one specific embodiment, step 804 is implemented to use a variation of a Rapidly-Exploring Random Tree (RRT) exploration technique. For example, step 804 can be implemented to use a continuous RRT* exploration technique. In general, a continuous RRT* exploration technique is graph traversal and pathfinding technique (i.e., a variant of A*) that uses randomized trees to identify candidate points that can be used to create valid pathways. In the continuous RRT* exploration technique randomized points within the geographic area can thus be selected and used to repeatedly identify potential path segments.

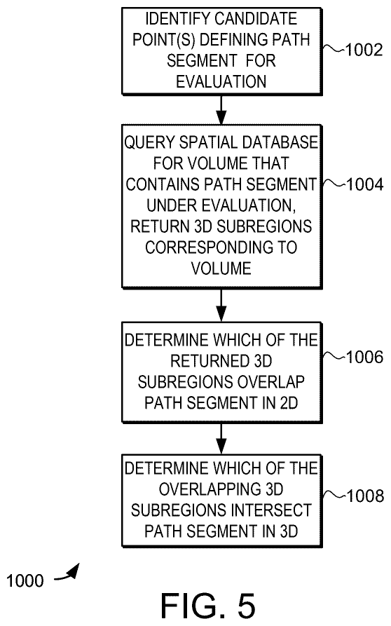

At step 806 the potential path segments are evaluated to determine if they are open to navigation. Specifically, step 806 determines if a potential path segment defined by the candidate points has an open line-of-sight path to allow for drone travel. Specific exemplary techniques for evaluating path segments for open line-of-sight travel will be discussed below with reference to method 1000 and FIG. 5.

At step 808 a cost factor is determined for potential path segments that were determined to be open for line-of-sight travel, and the open potential path segments are added to a preliminary navigation path network. Potential path segments that are determined to not have an open line-of-sight travel path are not added to the preliminary navigation path network.

In general, the cost factor describes the quality of path segment for drone navigation in a way that allows for the evaluation of path segments and the optimized selection of path segments for use in a navigation path. Stated another way, the cost factor can be implemented to quantify the quality of the path segment in providing a portion of a path to the destination point. As such, a variety of different metrics can be included in such cost factors, including distance. Likewise, a variety of different techniques can be used to determine such cost factor for potential path segments.

As one specific example, cost factors can be calculated as sums of Euclidean squared distances augmented by weighting factors. For example, the cost factors can be augmented by weighting factors based safety hazards, regulatory hazards, human caused hazards, available power, etc. With such cost factors are calculated for each potential path segment, a heuristic evaluation of the cost for potential path segments in the navigation path can be performed.

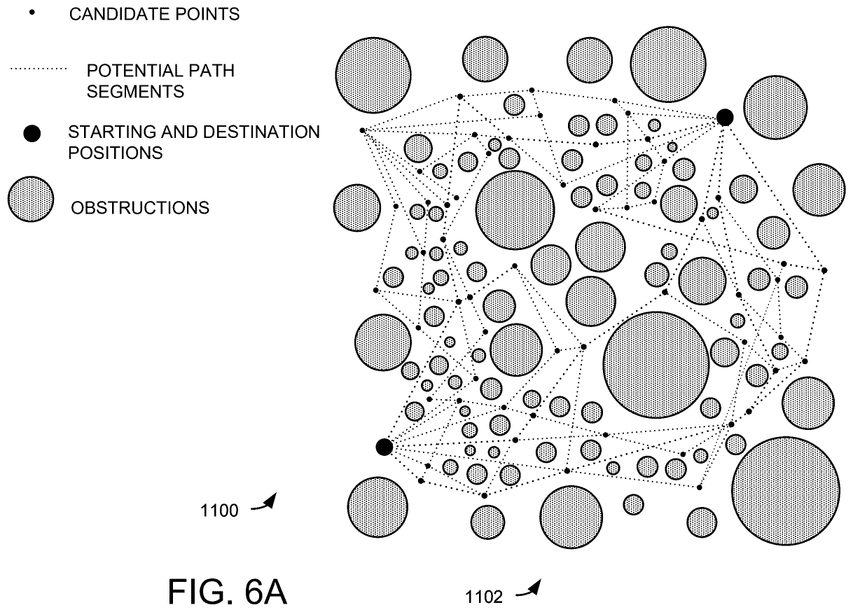

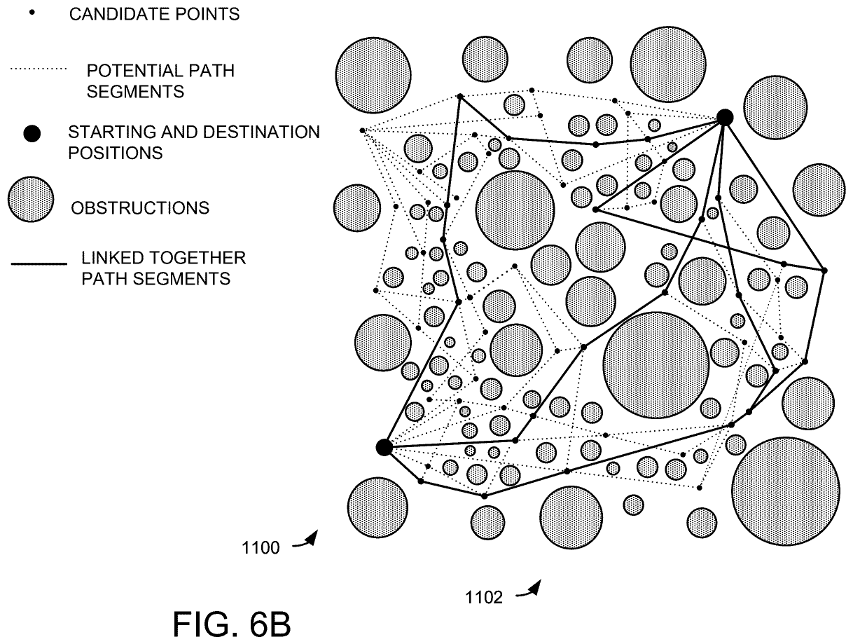

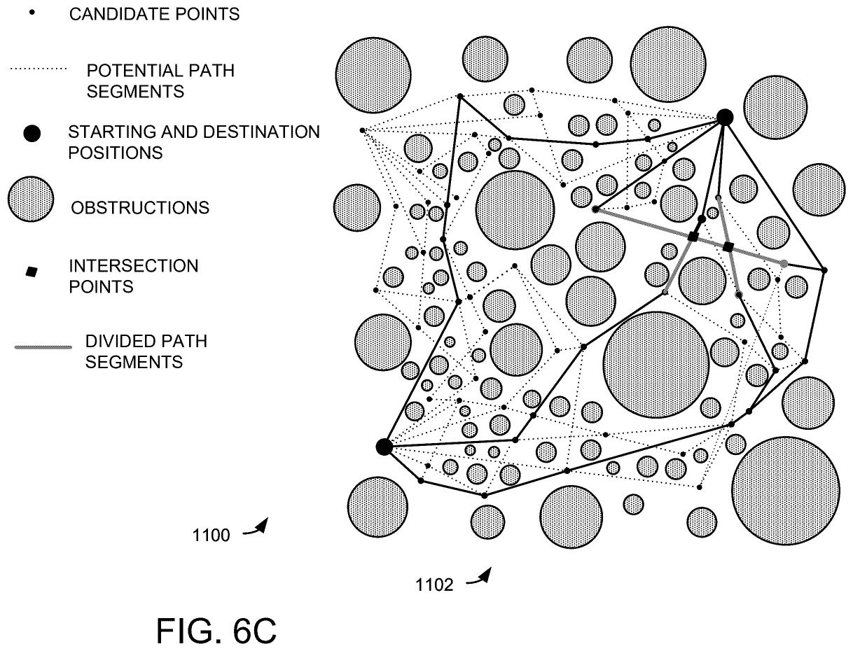

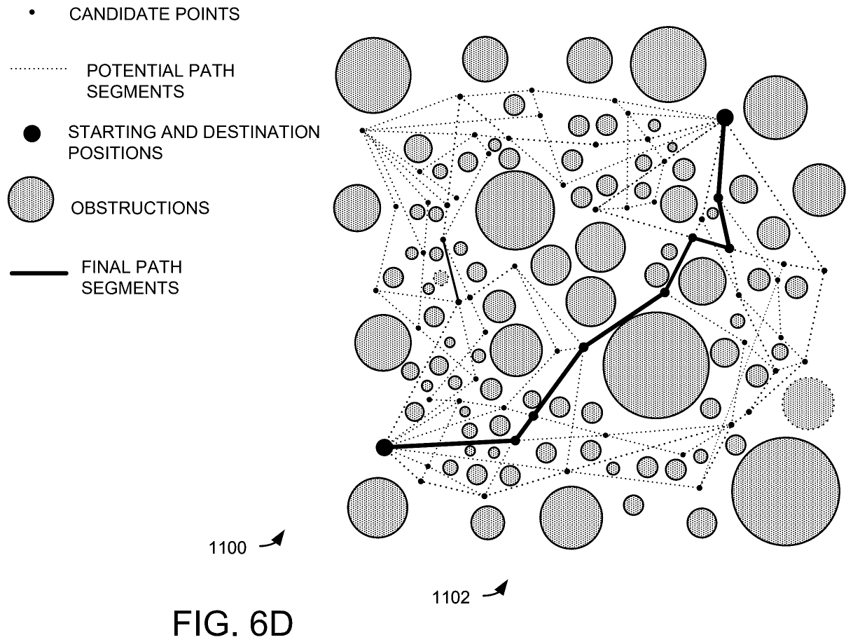

Turning briefly to FIG. 6A, an example of a preliminary navigation path network 1100 is illustrated schematically. The preliminary navigation path network 1100 is an example preliminary path network that can be generated using steps 802-808 as described above. As such, the preliminary navigation path network 1100 defines a plurality of candidate points and associated potential path segments. This preliminary navigation path network 1100 is illustrated in the context of starting and destination points and a plurality of obstructions in a geographic area 1102. It should be noted that the preliminary navigation path network 1100 is a relatively simple example, and that real world preliminary navigation path network could commonly include thousands of candidate points and potential path segments.

Returning to FIG. 3, at step 810 the potential path segments in the preliminary navigation path network are repeatedly linked together to generate a plurality of navigation paths. In general, this step comprises selecting path segments and linking them together to generate a plurality of navigation paths from the starting position to the destination position. And in some embodiments the cost factor of the segments can be used in the generating of the plurality of navigation paths. As one example, this step can be performed by using a selection method that favors lower cost path segments and disfavors high cost segments.

Turning briefly to FIG. 6B, an example of potential path segments in the preliminary navigation path network 1100 being linked to together to generate a plurality of navigation paths is illustrated schematically.

Returning to FIG. 3, at step 812 a final navigation path is determined from the plurality of navigation paths based at least in part on the cost factor of the potential path segments. In general, this step selects the final navigation path from the plurality of previously generated navigation paths in a way that that reduces or optimizes the cost of the final navigation path. As one specific example, a Dijkstra reduction of plurality of navigation paths can be used to generate the final navigation path from the previously generated plurality of navigation paths. Using the Dijkstra reduction results in the selection of an optimized, reduce cost path from the starting position to the destination. Specifically, Dijkstra reduction can find the shortest path through the collection of path segments produced by multiple executions of the RRT* path generation.

In another specific example of step 812, a final navigation path can be determined in part by identifying intersections in potential path segments and dividing the path segments at the identified intersections to introduce more candidate points in the plurality of navigation paths.

Turning now to FIG. 4, a method 900 for identifying a final navigation path is illustrated. As such, the method 900 is one example of how step 812 in method 800 can be implemented. In general, method 900 determines a final navigation path by identifying intersections in potential path segments and dividing the path segments at the identified intersections to introduce more candidate points in the plurality of navigation paths.

At step 902 a subset of navigation paths from the starting position to the destination position can be selected. This selection of navigation paths can be performed based on a variety of factors. For example, this selection can be performed based in part on the cost factors of the associated path segments in the navigation paths as discussed above.

At step 904 intersection points of segments in selected navigation paths are determined. At step 906 the segments of the selected navigation paths are divided at the determined intersection points.

Turning briefly to FIG. 6C, an example of a determination of the intersection of the potential path segments in a subset of selected navigation paths is illustrated. Additionally, the dividing the intersected navigation path segments into sections is illustrated. Specifically, FIG. 6C illustrates an example where three path segments of selected navigation paths intersect at two different intersection points. And in this illustrated example the three path segments can be divided into seven sections using these intersection points as dividing points.

Returning to method 900, at step 908 a final navigation path is determined by linking selected path segments and/or sections. A variety of techniques can be used in the linking of selected path segments and sections into a final navigation path. For example, a cost factor of the newly identified sections (i.e., the sections resulting from the dividing of segments at intersection points in step 906) can be calculated and used along with the cost factors of the undivided path segments in the selection of segments and/or sections for the final navigation path.

Thus, in this method a cost factor can be determined for each new section of path segment is created by the dividing segments at intersection points, and those cost factors of new sections used along with the cost factors of undivided path segments in selecting and linking of the sections and segments into the final navigation path.

For example, the subset of the navigation paths from the starting position to the destination position can be selected based at least in part on the cost factor of the potential path segments in the navigation paths. The intersection points of the selected subset of the navigation paths can then be determined, and the selected subset of the navigation paths divided into sections at the determined intersection points. A cost factor can then be calculated for each of these new sections resulting from the division. Finally, a final navigation path can be determined by selecting and linking the sections based on the cost factor.

Turning next to FIG. 6D, an example of a final navigation path created by selecting and linking the sections and path segments is illustrated. So generated, the final navigation path provides for the generation and selection of a valid and efficient drone path.

Turning now to FIG. 5, a method 1000 for evaluating path segments is illustrated. As such, the method 1000 is an example of a method that can be performed by a drone navigation system 260, and more specifically, the path segment evaluation module 256 of FIG. 2. Specifically, the method 1000 can be used to evaluate path segments for clear line-of-sight travel paths.

In general, the method 1000 determines if a path segment is subject to the presence of obstruction(s) in the light-of-sight travel path that would potentially interfere with line-of-sight travel. The method 1000 is thus one example of how path segments can be determined to be open to navigation in step 806 of FIG. 3, as was discussed above. And method 1000 utilizes a spatial obstruction database that includes obstruction data. However, in this case it should be noted that the obstruction data can include both data on structures and features (e.g., buildings, terrain, electromagnetic or other interference) and data on restricted areas (e.g., areas with restricted airspace or other no-go areas where the drone should not fly).

At step 1002 candidate point(s) defining a path segment are identified. As was described above with reference to steps 802 and 804 in method 800, a variety of techniques can be used to identify candidate points for a navigation path. For example, these points may be identified in step 804 using a random tree selection of points in the geographic region.

At step 1004, a spatial obstruction database is queried for a volume that contains the path segment under evaluation, and three-dimensional (3D) subregions corresponding to that volume are returned. In general, step 1004 is implemented to return all the subregions from the spatial obstruction database that could possibly intersect with the path segment under evaluation, where the subregions correspond to abstracted obstructions as described above. Stated another way, step 1004 can be implemented to return all the 3D subregions corresponding to a volume in the geographic region, where the volume contains the entire path segment under evaluation.

As described above, using an R-tree data structure in the spatial obstruction database allows for the representation of obstructions as abstracted 3D subregions, including varying sized cubes and parallelepipeds. The R-tree data structure further allows for the optimization of three-dimensional queries. Thus, implementing the spatial obstruction database with an R-tree data structure facilitates an efficient three dimensional query and return of 3D subregions corresponding to abstracted obstructions that could intersect the path segment under evaluation.

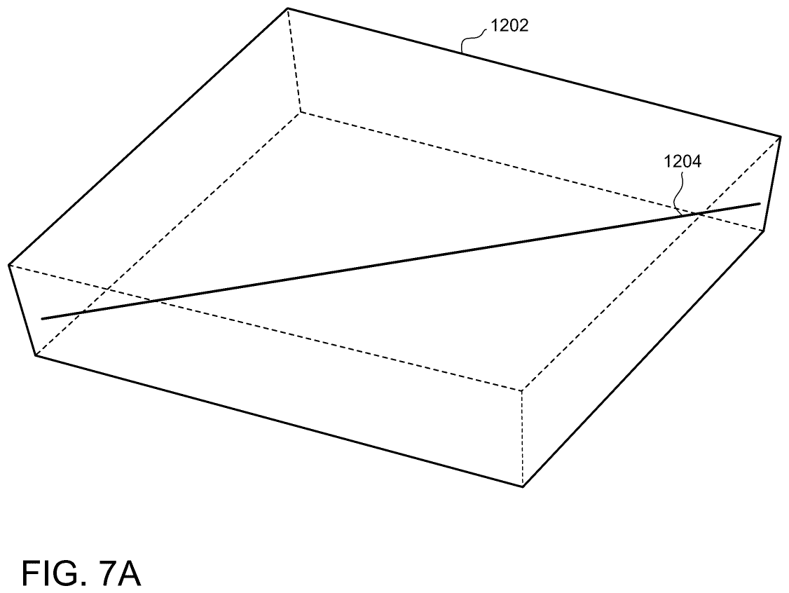

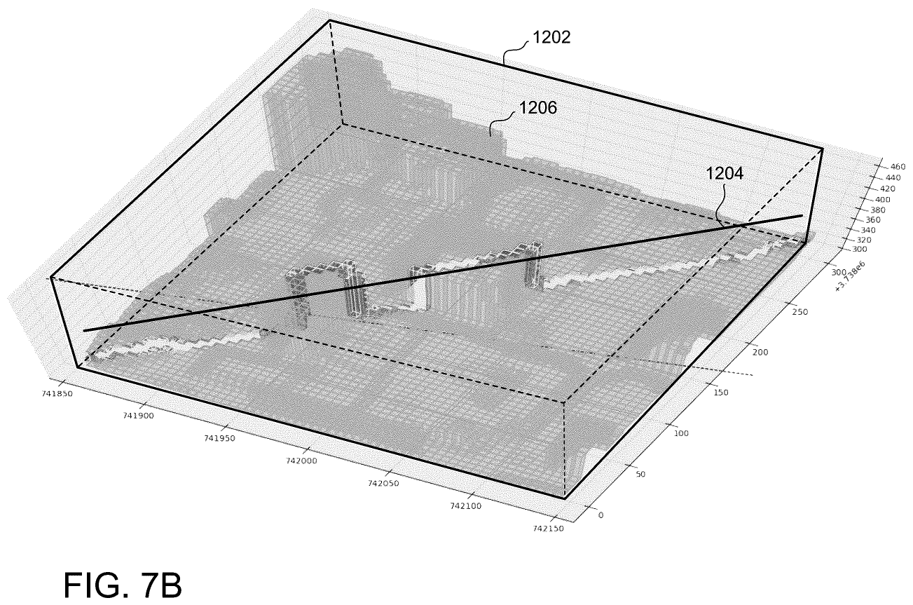

Turning briefly to FIG. 7A, an example volume 1202 that contains a path segment 1204 is illustrated schematically. As described, in step 1004 the three-dimensional (3D) subregions corresponding to that volume are returned. Turning now to FIG. 7B, exemplary returned 3D subregions 1206 contained within the volume 1202 are illustrated. In this example, each returned 3D subregion is a cuboid, with a height of the cuboid equal to the tallest obstructed point in the 3D subregion, although again this is just one example. These 3D subregions 706 contained within volume 1202 represent the abstracted obstructions that could possibly intersect with the path segment 1204.

Returning to method 1000 in FIG. 5, at step 1006 it is determined which returned 3D subregions overlap with the path segment in two dimensions. For example, in step 1006 it can be determined which of the 3D subregions returned in step 1004 overlap with the path segment in two dimensions that correspond to Easting and Northing axes. As another example, in step 1006 it can be determined which returned 3D subregions overlap with the path segment in two dimensions that correspond to latitude and longitude axes.

A variety of different techniques can be used to determine which returned 3D subregions overlap a path segment in two dimensions. For example, a line clipping technique can be used to determine where the path segment crosses the perimeter (e.g., perimeter of the footprint) of returned 3D subregions in two dimensions. Again, the footprint of 3D subregions can be in the form of rectangles or other polygons. Thus, a line clipping technique can be performed by determining the intersection of the path segment with the polygons representing the footprint of the returned 3D subregions. As a specific embodiment, a Liang-Barsky line clipping technique can be used to determine where the path segment crosses the perimeter of returned 3D subregions.

At step 1008, it is determined which of the overlapping 3D subregions intersect with the path segment in three dimensions. For example, in step 1008 it can be determined which of the 3D subregions that were determined to be overlapping in step 1006 intersect with the path segment when the height (or altitude) of the 3D subregions and the height (or altitude) of the overlapping portion of the path segment are considered. Stated another way, the altitudes of the 3D subregions that overlap the path segment in two dimensions with are compared with the attitudes of the overlapping portions of the path segment.

Path segments that are determined to intersect with overlapping 3D subregions are identified as obstructed, and thus in most cases would be discarded and not added to the navigation path network (e.g., during step 808 of method 800)

Conversely, path segments that are not determined to intersect with overlapping 3D subregions are identified as having a clear line-of-sight path, and thus can be added to the navigation path network during generation of the navigation path.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system comprising:
a spatial obstruction database for a geographic region, where the spatial obstruction database represents physical features and airspace restrictions in the geographic region as abstracted spatial obstructions with the spatial obstruction database; and
at least one processor configured to:
identify a starting position and a destination position in the geographic region;
repeatedly identify a potential path segment in the geographic region, and for each identified potential path segment:
determine if the potential path segment is open to navigation;
responsive to determining that the potential path segment is open to navigation, add the potential path segment to a navigation path network and determine a cost factor of the potential path segment;
repeatedly link together potential path segments in the navigation path network to generate a plurality of navigation paths from the starting position to the destination position; and
determine a final navigation path from the starting position to the destination position based at least in part on the cost factor of the potential path segments in the plurality of navigation paths.

2. The system of claim 1, wherein the at least one processor is configured to determine the final navigation path from the starting position to the destination position based at least in part on the cost factor of the potential path segments in the plurality of navigation paths by being configured to:
select a subset of the navigation paths from the starting position to the destination position based at least in part on the cost factor of the potential path segments in the navigation paths;
determine intersection points of the selected subset of the navigation paths;
divide the selected subset of the navigation paths into sections at the determined intersection points; and
link selected sections to determine the final navigation path from the starting position to the destination position.

3. The system of claim 2, wherein the at least one processor is configured to determine the final navigation path from the starting position to the destination position based at least in part on the cost factor of the potential path segments in the plurality of navigation paths by being configured to:
select a subset of the navigation paths from the starting position to the destination position based at least in part on the cost factor of the potential path segments in the navigation paths;
determine intersection points of the selected subset of the navigation paths;
divide the selected subset of the navigation paths into sections at the determined intersection points; and
calculate a cost factor for each of the sections; and
link selected sections to determine the final navigation path from the starting position to the destination position based at least in part on the calculated cost factors for each of the sections.

4. The system of claim 1, wherein the at least one processor is configured to repeatedly identify the potential path segment in the geographic region by utilizing a random tree selection of points in the geographic region.

5. The system of claim 1, wherein the at least one processor is configured to repeatedly identify the potential path segment in the geographic region by utilizing a random tree selection of points in the geographic region proximate the starting position and points proximate the destination position and points between the starting position and ending position.

6. The system of claim 1, wherein the at least one processor is configured to determine if the potential path segment is open to navigation by being configured to:
query the spatial obstructions database for a volume that contains the potential path segment and return the abstracted spatial obstructions from the spatial obstruction database that correspond to the volume;
determine if any of the returned abstracted spatial obstructions for the volume intersect with the potential path segment to determine if the potential path segment is unobstructed.

7. The system of claim 1, wherein the at least one processor is configured to determine if the potential path segment is open to navigation by being configured to:
query the spatial obstructions database for a volume that contains the potential path segment and return the abstracted spatial obstructions that correspond to physical features in the geographic region from the spatial obstruction database that correspond to the volume;
determine if any of the returned abstracted spatial obstructions for the volume that correspond to physical features in the geographic region intersect with the potential path segment to determine if the potential path segment is unobstructed by physical features;
query the spatial obstructions database for the volume that contains the potential path segment and return the abstracted spatial obstructions that correspond to airspace restrictions in the geographic region from the spatial obstruction database that correspond to the volume; and
determine if any of the returned abstracted spatial obstructions for the volume that correspond to airspace restrictions in the geographic region intersect with the potential path segment to determine if the potential path segment is unobstructed by airspace restrictions.

8. The system of claim 1, wherein the at least one processor is configured to determine the cost factor of the potential path segment by being configured to:
calculate a distance of the potential path segment; and
augment the calculated distance by at least one weighting factor, where the at least one weighting factor is based at least in part on a hazard associated with the potential path segment.

9. The system of claim 1, wherein the at least one processor is configured to determine the cost factor of the potential path segment by being configured to:
calculate a Euclidean squared distance of the potential path segment.

10. The system of claim 1, wherein the spatial obstruction database represents the abstracted spatial obstructions as subregions having a defined footprint and defined height.

11. The system of claim 1, wherein the spatial obstruction database represents the abstracted spatial obstructions as subregions having a parallelepiped shape.

12. The system of claim 1, wherein the spatial obstruction database represents the physical features in the geographic region as the abstracted spatial obstructions within the spatial obstruction database by being configured to:
represent the geographic region as a plurality of subregions; and
for each of the plurality of subregions that includes an obstruction, identify at least an obstructed high point and identifying the subregion as fully obstructed to the obstructed high point; and
wherein the spatial obstruction database is optimized for three-dimensional queries.

13. A method of generation a navigation path, comprising:
providing a spatial obstruction database for a geographic region, where the spatial obstruction database represents physical features and airspace restrictions in the geographic region as abstracted spatial obstructions with the spatial obstruction database;
identifying a starting position and a destination position in the geographic region;
repeatedly identifying a potential path segment in the geographic region, and for each identified potential path segment:
determining if the potential path segment is open to navigation;
responsive to determining that the potential path segment is open to navigation, adding the potential path segment to a navigation path network and determine a cost factor of the potential path segment;
repeatedly linking together potential path segments in the navigation path network to generate a plurality of navigation paths from the starting position to the destination position; and
determining a final navigation path from the starting position to the destination position based at least in part on the cost factor of the potential path segments in the plurality of navigation paths.

14. The method of claim 13, wherein the determining the final navigation path from the starting position to the destination position based at least in part on the cost factor of the potential path segments in the plurality of navigation paths is performed at least in party by:
selecting a subset of the navigation paths from the starting position to the destination position based at least in part on the cost factor of the potential path segments in the navigation paths;
determining intersection points of the selected subset of the navigation paths;
divide the selected subset of the navigation paths into sections at the determined intersection points; and
linking selected sections to determine the final navigation path from the starting position to the destination position.

15. The method of claim 13, wherein the determining the final navigation path from the starting position to the destination position based at least in part on the cost factor of the potential path segments in the plurality of navigation paths is performed at least in part by:
selecting a subset of the navigation paths from the starting position to the destination position based at least in part on the cost factor of the potential path segments in the navigation paths;
determining intersection points of the selected subset of the navigation paths;
dividing the selected subset of the navigation paths into sections at the determined intersection points; and
calculate a cost factor for each of the sections; and
linking selected sections to determine the final navigation path from the starting position to the destination position based at least in part on the calculated cost factors for each of the sections.

16. The method of claim 13, wherein the repeatedly identifying the potential path segment in the geographic region is performed at least in part by utilizing a random tree selection of points in the geographic region.

17. The method of claim 13, wherein the repeatedly identifying the potential path segment in the geographic region is performed at least in part by utilizing a random tree selection of points in the geographic region proximate the starting position and points proximate the destination position and points between the starting position and ending position.

18. The method of claim 13, wherein the determining if the potential path segment is open to navigation is performed at least in part by:
querying the spatial obstructions database for a volume that contains the potential path segment and return the abstracted spatial obstructions from the spatial obstruction database that correspond to the volume;
determining if any of the returned abstracted spatial obstructions for the volume intersect with the potential path segment to determine if the potential path segment is unobstructed.

19. The method of claim 13, wherein the determining if the potential path segment is open to navigation is performed at least in party by:
querying the spatial obstructions database for a volume that contains the potential path segment and return the abstracted spatial obstructions that correspond to physical features in the geographic region from the spatial obstruction database that correspond to the volume;
determining if any of the returned abstracted spatial obstructions for the volume that correspond to physical features in the geographic region intersect with the potential path segment to determine if the potential path segment is unobstructed by physical features;
querying the spatial obstructions database for the volume that contains the potential path segment and return the abstracted spatial obstructions that correspond to airspace restrictions in the geographic region from the spatial obstruction database that correspond to the volume; and
determining if any of the returned abstracted spatial obstructions for the volume that correspond to airspace restrictions in the geographic region intersect with the potential path segment to determine if the potential path segment is unobstructed by airspace restrictions.

20. The method of claim 13, wherein the determining the cost factor of the potential path segment is performed at least in part by:
calculating a distance of the potential path segment; and
augmenting the calculated distance by at least one weighting factor, where the at least one weighting factor is based at least in part on a hazard associated with the potential path segment.

21. The method of claim 13, wherein the determining the cost factor of the potential path segment is performed at least in part by:
calculating a Euclidean squared distance of the potential path segment.

22. The method of claim 13, wherein the spatial obstruction database represents the physical features in the geographic region as the abstracted spatial obstructions within the spatial obstruction database by being configured to:
represent the geographic region as a plurality of subregions; and
for each of the plurality of subregions that includes an obstruction, identify at least an obstructed high point and identifying the subregion as fully obstructed to the obstructed high point; and
wherein the spatial obstruction database is optimized for three-dimensional queries.
